(19) United States
(12) Patent Application Publication
(10) Pub. No.: US 2012/0309889 A1
(43) Pub. Date: Dec. 6, 2012

(54) POLYESTERS WITH STYRENE COPOLYMERS

(75) Inventors: Martin Weber, Maikammer (DE); Peter Eibeck, Speyer (DE); Nok-young Choi, Ludwigshafen (DE)

(73) Assignee: BASF SE, Ludwigshafen (DE)

(21) Appl. No.: 13/484,994

(22) Filed: May 31, 2012

Related U.S. Application Data
(60) Provisional application No. 61/491,908, filed on Jun. 1, 2011.

(51) Int. Cl. C08L 51/00

(52) U.S. Cl. 524/504; 525/74

(57) ABSTRACT

A thermoplastic molding composition containing
A) at least one polyester,
B) optionally one polycarbonate,
C) a copolymer made of
   c₁) styrene or of substituted styrenes of the formula I

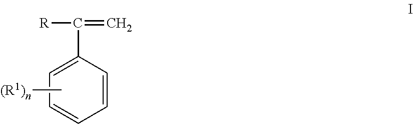

c₂) at least one unsaturated nitrile,
D) a copolymer made of
   d₁) structural units deriving from one or more vinylaromatic monomers,
   d₂) structural units deriving from one or more vinyl cyanides,
   d₃) structural units deriving from one or more dicarboxylic anhydrides, and
   d₄) optionally structural units deriving from other copolymerizable monomers.

The invention relates to a thermoplastic molding composition comprising

A) from 2 to 98.5% by weight of at least one polyester
B) from 0 to 70% by weight of at least one polycarbonate
C) from 1 to 97.5% by weight of a copolymer made of
c₁) from 60 to 95% by weight of styrene or of substituted styrenes of the general formula I or a mixture of these

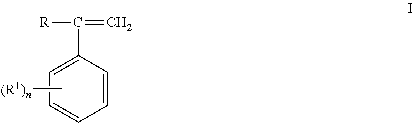

in which R is an alkyl radical having from 1 to 8 carbon atoms or a hydrogen atom and R¹ is an alkyl radical having from 1 to 8 carbon atoms, and n has the value 1, 2, or 3, and
c₂) from 5 to 40% by weight of at least one unsaturated nitrile,
   D) from 0.5 to 30% by weight of a copolymer made of
d₁) from 49.5 to 93.5% by weight of structural units deriving from one or more vinylaromatic monomers,
d₂) from 6 to 50% by weight of structural units deriving from one or more vinyl cyanides,
d₃) from 0.5 to 2.4% by weight of structural units deriving from one or more dicarboxylic anhydrides, and
d₄) from 0 to 25% by weight of structural units deriving from other copolymerizable monomers,
   where each of the % by weight values is based on the total weight of the structural units deriving from components d₁, d₂, d₃, and d₄, and the total of these % by weight values is 100% by weight,
      E) from 0 to 50% by weight of a rubber which comprises no diene, and
      F) from 0 to 60% by weight of other additives,
      where the total of the percentages by weight of A) to F) is 100%.

The invention further relates to the use of the thermoplastic molding compositions for producing fibers, foils, and moldings, and also to fibers, foils, and moldings which are obtainable from the thermoplastic molding compositions of the invention.

Polymer mixtures are of increasing interest in industry, since they provide tailored combinations of properties. Of particular interest here are polymer mixtures made of incompatible polymers having unusual combinations of properties.

Polymer mixtures based on polyesters and on styrene copolymers have been known for years (DE 33 36 499, U.S. Pat. No. 4,485,212, EP 135 677). However, these products have inadequate mechanical properties because of the incompatibility of polyesters with styrene copolymers.

The literature therefore discusses various approaches for improving the compatibility of the phases, particularly by using functionalized styrene copolymers (EP 284 086, U.S. Pat. No. 4,902,749, U.S. Pat. No. 5,310,793, Lee P.-C., Kuo W.-F., Chang F.-C., Polymer 1994, 35, 5641) and reactive acrylate copolymers (EP 573 680, U.S. Pat. No. 4,352,904, Hage E., Hale W., Keskkula, Paul D. R. Polymer, 1997, 38, 3237).

DE 37 33 829 relates to glassfiber-reinforced molding compositions based on polyesters and on styrene copolymers, using styrene-acrylonitrile-maleic anhydride terpolymers to improve compatibility. In contrast to the improvement in mechanical properties, there is marked impairment of processing stability.

US 2010/0152359 A1 describes mixtures made of polyesters, styrene copolymers, and graft copolymers, where a recyclate is used as polyester. The products mentioned have improved chemicals resistance. However, there is no mention of fiber-reinforced products.

DE 10 2009 055 403 relates to molding compositions based on polyesters, on butadiene-containing styrene copolymers, and on reactive styrene copolymers, as compatibilizers.

It was therefore an object of the present invention to provide blends made of polyester with SAN and optionally with rubbers, where these exhibit good mechanical properties, in particular toughness, good stability in long-term use, and high processing stability, particularly at the mixing temperatures required for fiber-reinforced molding compositions.

Accordingly, the molding compositions defined in the introduction have been discovered. Preferred embodiments can be found in the dependent claims.

The molding compositions of the invention comprise, as component (A), from 2 to 98.5% by weight, preferably from 20 to 97.5% by weight, and in particular from 20 to 80% by weight, of at least one thermoplastic polyester.

Use is generally made of polyesters A) based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety.

Polyalkylene terephthalates of this type are known per se and are described in the literature. Their main chain comprises an aromatic ring which derives from the aromatic dicarboxylic acid. There may also be substitution in the aromatic ring, e.g. by halogen, such as chlorine or bromine, or by C₁-C₄-alkyl, such as methyl, ethyl, iso- or n-propyl, or n-, iso- or tert-butyl.

These polyalkylene terephthalates may be produced by reacting aromatic dicarboxylic acids, or their esters or other ester-forming derivatives, with aliphatic dihydroxy compounds in a manner known per se.

Preferred dicarboxylic acids are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Particularly preferred polyesters (A) are polyalkylene terephthalates derived from alkanediols having from 2 to 6 carbon atoms. Among these, particular preference is given to polyethylene terephthalate, polypropylene terephthalate and polybutylene terephthalate, and mixtures of these. Preference is also given to PET and/or PBT which comprise, as other monomer units, up to 1% by weight, preferably up to 0.75% by weight, of 1,6-hexanediol and/or 2-methyl-1,5-pentanediol.

The viscosity number of the polyesters (A) is generally in the range from 50 to 220, preferably from 80 to 160 measured in 0.5% strength by weight solution in a phenol/o-dichlorobenzene mixture (in a weight ratio of 1:1) at 25° C. in accordance with ISO 1628.

Particular preference is given to polyesters whose terminal carboxy group content is up to 100 mval/kg of polyester, preferably up to 50 mval/kg of polyester and in particular up to 40 mval/kg of polyester. Polyesters of this type may be produced, for example, by the process of DE-A 44 01 055. The terminal carboxy group content is usually determined by titration methods (e.g. potentiometry).

Particularly preferred molding compositions comprise, as component A), a mixture of polyesters other than PBT, for example polyethylene terephthalate (PET). The proportion of the polyethylene terephthalate, for example, in the mixture is preferably up to 50% by weight, in particular from 1.0 to 35% by weight, based on 100% by weight of A).

It is also advantageous to use PET recyclates (also termed scrap PET), optionally mixed with polyalkylene terephthalates, such as PBT.

Recyclates are generally:
1) those known as post-industrial recyclates: these are production wastes during polycondensation or during processing, e.g. sprues from injection molding, start-up material from injection molding or extrusion, or edge trims from extruded sheets or films.
2) post-consumer recyclates: these are plastic items which are collected and treated after utilization by the end consumer. Blow-molded PET bottles for mineral water, soft drinks and juices are easily the predominant items in terms of quantity.

Both types of recycled material may be used either in the form of regrind or in the form of pellets. In the latter case, the crude recyclates are separated and purified and then melted and pelletized using an extruder. This usually facilitates handling and free flow, and metering for further steps in processing.

The recyclates used may either be pelletized or in the form of regrind. The edge length should not be more than 10 mm, preferably less than 8 mm.

Because polyesters undergo hydrolytic cleavage during processing (due to traces of moisture) it is advisable to predry the recyclate. Residual moisture content after drying is preferably <0.2%, in particular <0.05%.

Another group to be mentioned is that of fully aromatic polyesters deriving from aromatic dicarboxylic acids and aromatic dihydroxy compounds.

Suitable aromatic dicarboxylic acids are the compounds previously described for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the general formula

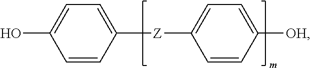

where Z is an alkylene or cycloalkylene group having up to 8 carbon atoms, an arylene group having up to 12 carbon atoms, a carbonyl group, a sulfonyl group, oxygen or sulfur, or a chemical bond, and m is from 0 to 2. The phenylene groups of the compounds may also have substitution by C₁-C₆-alkyl or alkoxy groups, and fluorine, chlorine or bromine.

Examples of parent compounds for these compounds are

dihydroxybiphenyl,
di(hydroxyphenyl)alkane,
di(hydroxyphenyl)cycloalkane,
di(hydroxyphenyl) sulfide,
di(hydroxyphenyl)ether,
di(hydroxyphenyl) ketone,
di(hydroxyphenyl) sulfoxide,
α,α′-di(hydroxyphenyl)dialkylbenzene,
di(hydroxyphenyl) sulfone, di(hydroxybenzoyl)benzene,
resorcinol, and
hydroquinone, and also the ring-alkylated and ring-halogenated derivatives of these.

Among these, preference is given to
4,4′-dihydroxybiphenyl,
2,4-di(4′-hydroxyphenyl)-2-methylbutane,
α,α′-di(4-hydroxyphenyl)-p-diisopropylbenzene,
2,2-di(3′-methyl-4′-hydroxyphenyl)propane, and
2,2-di(3′-chloro-4′-hydroxyphenyl)propane,
   and in particular to
2,2-di(4′-hydroxyphenyl)propane
2,2-di(3′,5-dichlorodihydroxyphenyl)propane,
1,1-di(4′-hydroxyphenyl)cyclohexane,
3,4′-dihydroxybenzophenone,
4,4′-dihydroxydiphenyl sulfone and
2,2-di(3′,5′-dimethyl-4′-hydroxyphenyl)propane
   and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in US-A 3651 014. Corresponding products are also available commercially, e.g. Hytrel® (DuPont).

According to the invention, halogen-free polycarbonates can also be used as component B in amounts of from 0 to 70% by weight, preferably up to 60% by weight. Examples of suitable halogen-free polycarbonates are those based on biphenols of the general formula

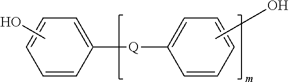

where Q is a single bond, a C₁-C₈-alkylene group, a C₂-C₃-alkylidene group, a C₃-C₆-cycloalkylidene group, a C₆-C₁₂-arylene group, or —O—, —S— or —SO₂—, and m is a whole number from 0 to 2.

The phenylene radicals of the biphenols may also have substituents, such as C₁-C₆-alkyl or C₁-C₆-alkoxy.

Examples of preferred biphenols of the formula mentioned above are hydroquinone, resorcinol, 4,4′-dihydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as component B, and preference is given to the copolycarbonates of bisphenol A, as well as to bisphenol A homopolymer.

Suitable polycarbonates may be branched in a known manner, specifically and preferably by incorporating 0.05 to 2.0 mol %, based on the total of the biphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to an average molar mass M_{w} (weight-average) of from 10 000 to 200 000 g/mol, preferably from 20 000 to 80 000 g/mol.

The biphenols of the general formula are known per se or can be produced by known processes.

The polycarbonates may, for example, be produced by reacting the biphenols with phosgene in the interfacial process, or with phosgene in the homogeneous-phase process (known as the pyridine process), and in each case the desired molecular weight may be achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE A 3506472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates composed of halogen-free biphenols, halogen-free chain terminators, and optionally halogen-free branching agents, where the content of subordinate amounts at the ppm level of hydrolyzable chlorine, resulting, for example, from the preparation of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable components A) which may be mentioned are amorphous polyester carbonates, where during the preparation process phosgene has been replaced by aromatic dicarboxylic acid units, such as isophthalic acid and/or terephthalic acid units. Reference may be made at this point to EP-A 711 810 for further details.

EP-A 365 916 describes other suitable copolycarbonates having cycloalkyl radicals as monomer units.

It is also possible for bisphenol A to be replaced by bisphenol TMC. Polycarbonates of this type are obtainable from Bayer with the trademark APEC HT®.

The molding compositions of the invention comprise, as component C), from 1 to 97.5% by weight, preferably from 1 to 80% by weight, and in particular from 1 to 20% by weight, of a copolymer made of
C₁) from 60 to 95% by weight, preferably from 70 to 85% by weight, of styrene or of substituted styrenes of the general formula I or a mixture of these

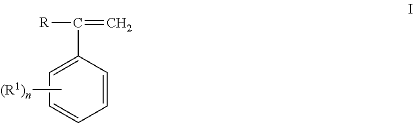

in which R is an alkyl radical having from 1 to 8 carbon atoms or a hydrogen atom and R¹ is an alkyl radical having from 1 to 8 carbon atoms, and n has the value 1, 2, or 3, and
C₂) from 5 to 40% by weight, preferably from 15 to 30% by weight, of at least one unsaturated nitrile.

Preferred radicals R are methyl, ethyl, and hydrogen, and

preferred radicals R¹ are methyl and ethyl.

Preferred components C₁) are styrene and α-methylstyrene, and mixtures of these.

Preferred components C₂) are acrylonitrile and methacrylonitrile, and mixtures of these.

The copolymers C are resinous, thermoplastic, and rubber-free. Particularly preferred copolymers C are those made of styrene and acrylonitrile, made of α-methylstyrene and acrylonitrile, or made of styrene, α-methylstyrene and acrylonitrile. It is also possible to make simultaneous use of a plurality of the copolymers described.

The copolymers C are known per se and can be produced via free-radical polymerization, in particular via emulsion polymerization, suspension polymerization, solution polymerization, or bulk polymerization. They have intrinsic viscosities in the range from 40 to 160, and this corresponds to average molecular weights Mw (weight average) of from 40 000 to 2 000 000.

The molding compositions of the invention comprise, as component D), from 0.5 to 30% by weight, preferably from 1 to 20% by weight, and in particular from 1 to 10% by weight (based on A to F) of a copolymer made of
d₁) from 49.5 to 93.5% by weight of structural units deriving from one or more vinylaromatic monomers,
d₂) from 6 to 50% by weight of structural units deriving from one or more vinyl cyanides,
d₃) from 0.5 to 2.4% by weight of structural units deriving from one or more dicarboxylic anhydrides, and
d₄) from 0 to 25% by weight of structural units deriving from other copolymerizable monomers,
   where each of the % by weight values is based on the total weight of the structural units deriving from components d₁, d₂, d₃, and d₄, and the total of these % by weight values is 100% by weight.

Preferred components D comprise

d₁) from 49.2 to 93.2% by weight
d₂) from 6 to 50% by weight
d₃) from 0.8 to 2.2% by weight
d₄) from 0 to 25% by weight.

Any of the vinylaromatic monomers known to the person skilled in the art and described in the prior art, for example in DE 100 58 302 A1, can be used as component d₁); it is preferable to use styrene, α-methylstyrene, p-methylstyrene, tert-butylstyrene, vinylnaphthalene, or a mixture of these; it is particularly preferably to use styrene.

Any of the vinyl cyanides known to the person skilled in the art and described in the prior art, for example in DE 25 40 517 A1, can be used as component d₂); it is preferable to use acrylonitrile, methacrylonitrile, or a mixture of these; it is particularly preferable to use acrylonitrile.

Any of the dicarboxylic anhydrides known to the person skilled in the art and described in the prior art can be used as component d₃); it is preferable to use maleic anhydride, methylmaleic anhydride, itaconic anhydride, or a mixture of these; it is particularly preferable to use maleic anhydride.

Component d₄) used in the copolymers D) of the invention can comprise other monomers which are familiar to the person skilled in the art and which can be polymerized with components d₁), d₂), and d₃), and which differ from these.

It is particularly preferable that the copolymers D) are composed of styrene-acrylonitrile-maleic anhydride copolymers.

The copolymers D) are produced via bulk polymerization or solution polymerization, but preferably by solution polymerization in the presence of an organic solvent, such as cyclohexane, ethylbenzene, toluene, or dimethyl sulfoxide, preferably ethylbenzene.

In the case of both solution polymerization and bulk polymerization, the polymerization reaction can in principle be initiated via addition of chemical polymerization initiators, as described by way of example in DE 100 58 302 A1; however, it is preferable that the initiation is purely thermal, i.e. without any addition of a polymerization initiator. The production process can be a batch or semibatch process, but preference is given to continuous conduct of the process.

In one particularly preferred embodiment of the process of the invention, a process is conducted continuously under steady-state conditions; the expression “under steady-state conditions” means that the concentrations of all of the reactants and the constitution of the copolymers A) formed remain practically constant over the reaction time. (Information relating to the relationship between monomer constitution and polymer constitution, and relating to the steady-state conduct of the reaction can in particular be found in EP 0 001 625 A1 and DE 25 40 517 A1).

Suitable process parameters, such as pressure, temperature, residence times, etc., suitable apparatuses for conduct of the processes, and also suitable quantitative flow rates for the monomers, and for the solvents if present, and for the initiators if present and for any other additions present in the polymerization reaction are known to the person skilled in the art and are described in the prior art.

The methods known to the person skilled in the art and described in the prior art can be used for work-up of the polymerization mixture and isolation of the copolymers D), an example being inert-gas stripping or application of vacuum to remove low-molecular-weight compounds.

The difference between the nitrile content of preferred components D) and the nitrile content of component C) is less than 10% by weight.

Amounts of from 0 to 50% by weight, based on the entirety of components A to F, of a graft copolymer or of a mixture of different graft copolymers is/are used as component E) in the molding compositions of the invention. Preferred molding compositions of the invention comprise from 1 to 40% by weight, particularly preferably from 1 to 20% by weight, of at least one graft copolymer E.

The graft polymers E are composed of
E₁) from 40 to 80% by weight, preferably from 50 to 70% by weight, of a graft base made of an elastomeric polymer based on alkyl acrylates having from 1 to 8 carbon atoms in the alkyl radical and having a glass transition temperature below 0° C.
E₂) from 20 to 60% by weight, preferably from 30 to 50% by weight, of a graft made of
E₂₁) from 60 to 95% by weight, preferably from 70 to 85% by weight, of styrene or of substituted styrenes of the general formula I
E₂₂) from 5 to 40% by weight, preferably from 15 to 30% by weight, of at least one unsaturated nitrile, preferably acrylonitrile or methacrylonitrile, or a mixture of these.

Polymers that can be used for the graft base E₁ are those having glass transition temperature below 10° C., preferably below 0° C., particularly preferably below −20° C. By way of example, these are elastomers based on C1-C8-alkyl acrylates, which optionally can comprise other comonomers.

Preference is given to graft bases E₁ which are composed of
E₁₁) from 69.9 to 99.9% by weight, preferably 99% by weight, of at least one alkyl acrylate having from 1 to 8 carbon atoms in the alkyl radical, preferably n-butyl acrylate and/or 2-ethylhexyl acrylate, in particular n-butyl acrylate as sole alkyl acrylate,
E₁₂) from 0 to 30% by weight, in particular from 20 to 30% by weight, of another copolymerizable monoethylenically unsaturated monomer, such as styrene, acrylonitrile, methyl methacrylate, or vinyl methyl ether, or a mixture of these, and
E₁₃) from 0.1 to 5% by weight, preferably from 1 to 4% by weight, of a copolymerizable, polyfunctional, preferably bi- or trifunctional, monomer which brings about crosslinking.

Suitable b- or polyfunctional crosslinking monomers E₁₃) are monomers which preferably comprise two, or else optionally three or more, ethylenic double bonds capable of copolymerization and not conjugated in 1,3-positions. Examples of suitable crosslinking monomers are divinylbenzene, diallyl maleate, diallyl fumarate, diallyl phthalate, triallyl cyanurate, and triallyl isocyanurate. The acrylate of tricyclodecenyl alcohol has proven to be a particularly advantageous crosslinking monomer (cf. DE-A 12 60 135).

Graft bases of this type are known per se and are described in the literature, for example in DE-A 31 49 358.

Among the grafts E₂, preference is given to those in which E₂₁ is styrene or α-methylstyrene or, a mixture of these, and in which E₂₂ is acrylonitrile or methacrylonitrile. Preferred monomer mixtures used are especially styrene and acrylonitrile or α-methylstyrene and acrylonitrile. The grafts are obtainable via copolymerization of components E₂₁ and E₂₂.

The graft base E₁ of the graft polymers E), which is composed of components E₁₁, and optionally E₁₂, and E₁₃, is also termed ASA rubber. The production process is known per se and is described by way of example in DE-A 28 26 925, DE-A 31 49 358, and DE-A 3414 118.

The graft polymers E can by way of example be produced by the method described in DE-C 12 60 135.

The graft (graft shell) of the graft polymers can have a single- or two-stage structure.

In the case of the single-stage structure of the graft shell, a mixture of the monomers E₂₁ and E₂₂ in the desired ratio by weight in the range from 95:5 to 50:50, preferably from 90:10 to 65:35, is polymerized in a known manner (cf. by way of example DE-A 28 26 925), preferably in emulsion, in the presence of the elastomer E₁.

In the case of a two-stage structure of the graft shell E₂, the 1st stage generally makes up from 20 to 70% by weight, preferably from 25 to 50% by weight, based on E₂. It is preferable to produce it by using only styrene or substituted styrenes, or a mixture of these (E₂₁).

The 2nd stage of the graft shell generally makes up from 30 to 80% by weight, in particular from 50 to 75% by weight, based in each case on E₂. It is produced by using mixtures made of the monomers E₂₁ and of the nitriles E₂₂ in a ratio by weight E₂₁/E₂₂ which is generally from 90:10 to 60:40, in particular from 80:20 to 70:30.

The graft polymerization conditions are preferably selected in such a way that resultant particle sizes are from 50 to 700 nm (d50 value of the cumulative mass distribution). Measures for this are known and are described by way of example in DE-A 2826925.

The seed latex process can be used for direct production of a coarse-particle rubber dispersion.

In order to obtain products having maximum toughness, it is often advantageous to use a mixture of at least two graft polymers with different particle size.

In order to achieve this, the particles of the rubber are enlarged in a known manner, e.g. via agglomeration, so that the latex has a bimodal structure (from 50 to 180 nm and from 200 to 700 nm).

In one preferred embodiment, a mixture made of two graft polymers is used and has particle diameters (d50 value of the cumulative mass distribution) of from 50 to 180 nm and, respectively, from 200 to 700 nm in a ratio by weight of from 70:30 to 30:70.

The chemical structure of the two graft polymers is preferably the same, but the shell of the coarse-particle graft polymer in particular can also have a two-stage structure.

It is also possible to use ethylene copolymers, ethylene-propylene copolymers, polyester elastomers, or thermoplastic polyurethanes as component E).

These are very generally copolymers which are preferably composed of at least two of the following monomers: ethylene, propylene, isobutene, chloroprene, vinyl acetate, styrene, acrylonitrile, and acrylate or methacrylate respectively having from 1 to 18 carbon atoms in the alcohol component.

Polymers of this type are described by way of example in Houben-Weyl, Methoden der organischen Chemie [Methods of organic chemistry], vol. 14/1 (Georg-Thieme-Verlag, Stuttgart, 1961), pp. 392 to 406, and in the monograph by C. B. Bucknall, “Toughened Plastics” (Applied Science Publishers, London, 1977).

The molding compositions of the invention can comprise, as component F), from 0 to 60% by weight, in particular up to 50% by weight, of other additives.

The molding compositions of the invention can comprise, as component F), from 0 to 5% by weight, preferably from 0.05 to 3% by weight, and in particular from 0.1 to 2% by weight, of at least one ester or amide of saturated or unsaturated aliphatic carboxylic acids having from 10 to 40, preferably from 16 to 22, carbon atoms with saturated aliphatic alcohols or amines having from 2 to 40, preferably from 2 to 6, carbon atoms.

The carboxylic acids may be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono-, di- or triamines. Examples of these are stearylamine, ethylenediamine, propylenediamine, hexamethylenediamine, di(6-aminohexyl)amine, particular preference being given to ethylenediamine and hexamethylenediamine. Correspondingly, preferred esters or amides are glycerol distearate, glycerol tristearate, ethylenediamine distearate, glycerol monopalmitate, glycerol trilaurate, glycerol monobehenate, and pentaerythritol tetrastearate.

It is also possible to use mixtures of various esters or amides, or esters with amides combined, the mixing ratio here being as desired.

Fibrous or particulate fillers F) which may be mentioned are carbon fibers, glass fibers, glass beads, amorphous silica, asbestos, calcium silicate, calcium metasilicate, magnesium carbonate, kaolin, chalk, powdered quartz, mica, barium sulfate, and feldspar, the amounts used of these being up to 60% by weight, in particular up to 50% by weight.

Preferred fibrous fillers which may be mentioned are carbon fibers, aramid fibers, and potassium titanate fibers, particular preference being given to glass fibers in the form of E glass. The forms used of these may be the commercially available forms of chopped glass or rovings.

The fibrous fillers may have been surface-pretreated with a silane compound to improve compatibility with the thermoplastic.

Suitable silane'compounds are those of the general formula

(X—(CH₂)ₙ)ₖ—Si—(O—CₘH₂ₘ₊₁)₄₋ₖ

where the substituents are:

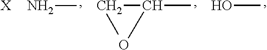

n is a whole number from 2 to 10, preferably from 3 to 4
m is a whole number from 1 to 5, preferably from 1 to 2
k is a whole number from 1 to 3, preferably 1.

Preferred silane compounds are aminopropyltrimethoxysilane, aminobutyltrimethoxysilane, aminopropyltriethoxysilane, aminobutyltriethoxysilane, and also the corresponding silanes which comprise a glycidyl group as substituent X.

The amounts generally used of the silane compounds for surface coating are from 0.05 to 5% by weight, preferably from 0.5 to 1.5% by weight, and in particular from 0.8 to 1% by weight (based on F).

Acicular mineral fillers are also suitable.

For the purposes of the invention, acicular mineral fillers are mineral fillers with very pronounced acicular character. An example which may be mentioned is acicular wollastonite. The L/D (length/diameter) ratio of the mineral is preferably from 8:1 to 35:1, with preference from 8:1 to 11:1. Optionally, the mineral filler may have been pretreated with the abovementioned silane compounds; however, this pretreatment is not essential.

Other fillers which may be mentioned are kaolin, calcined kaolin, talc powder, and chalk. The thermoplastic molding compositions of the invention can comprise, as component F, conventional processing aids, such as stabilizers, oxidation retarders, agents to counteract decomposition by heat and decomposition by ultraviolet light, lubricants and mold-release agents, colorants, such as dyes and pigments, nucleating agents, plasticizers, etc.

Examples which may be mentioned of oxidation retarders and heat stabilizers are sterically hindered phenols and/or phosphites, hydroquinones, aromatic secondary amines, such as diphenylamines, various substituted members of these groups, and mixtures of these in concentrations of up to 1% by weight, based on the weight of the thermoplastic molding compositions.

UV stabilizers that may be mentioned, where the amounts used of these are generally up to 2% by weight, based on the molding composition, are various substituted resorcinols, salicylates, benzotriazoles, and benzophenones.

Transesterification stabilizers that may be mentioned are Irgafos® PEPQ, and also phosphates (e.g. monozinc phosphate).

Colorants which may be added are inorganic pigments, such as titanium dioxide, ultramarine blue, iron oxide, and carbon black, and also organic pigments, such as phthalocyanines, quinacridones and perylenes, and also dyes, such as nigrosine and anthraquinones. Nucleating agents which may be used are sodium phenylphosphinate, alumina, silica, and preferably talc.

Other lubricants and mold-release agents are usually used in amounts of up to 1% by weight. Preference is given to long-chain fatty acids (e.g. stearic acid or behenic acid), salts of these (e.g. calcium stearate or zinc stearate) or montan waxes (mixtures of straight-chain saturated carboxylic acids having chain lengths of from 28 to 32 carbon atoms), or calcium montanate or sodium montanate, or low-molecular-weight polyethylene waxes or low-molecular-weight polypropylene waxes.

Examples of plasticizers which may be mentioned are dioctyl phthalates, dibenzyl phthalates, butyl benzyl phthalates, hydrocarbon oils and N-(n-butyl)benzenesulfonamide.

The inventive molding compositions may also comprise from 0 to 2% by weight of fluorine-containing ethylene polymers. These are polymers of ethylene with a fluorine content of from 55 to 76% by weight, preferably from 70 to 76% by weight.

Examples of these are polytetrafluoroethylene (PTFE), tetrafluoroethylene-hexafluoropropylene copolymers and tetrafluoroethylene copolymers with relatively small proportions (generally up to 50% by weight) of copolymerizable ethylenically unsaturated monomers. These are described, for example, by Schildknecht in “Vinyl and Related Polymers”, Wiley-Verlag, 1952, pages 484-494 and by Wall in “Fluoropolymers” (Wiley Interscience, 1972).

These fluorine-containing ethylene polymers have homogeneous distribution in the molding compositions and preferably have a particle size d₅₀ (numeric average) in the range from 0.05 to 1 μm, in particular from 0.1 to 5 μm. These small particle sizes can particularly preferably be achieved by the use of aqueous dispersions of fluorine-containing ethylene polymers and the incorporation of these into a polyester melt.

The inventive thermoplastic molding compositions may be produced by methods known per se, by mixing the starting components in conventional mixing apparatus, such as screw extruders, Brabender mixers or Banbury mixers, and then extruding them. The extrudate may be cooled and comminuted. It is also possible to premix individual components and then to add the remaining starting materials individually and/or likewise in a mixture. The mixing temperatures are generally from 230 to 290° C.

In another preferred mode of operation, components C) and D), and also optionally E and/or F) can be mixed with a polyester prepolymer, compounded, and pelletized. The resultant pellets are then solid-phase condensed under inert gas continuously or batchwise at a temperature below the melting point of component A) until the desired viscosity is reached.

The thermoplastic molding compositions of the invention feature good processing and good thermal stability together with good mechanical properties. In particular, there is an improvement in toughness, and also in processing stability at high temperatures.

The materials are suitable for producing fibers, foils, and moldings of any type, in particular for applications as plugs, switches, housing parts, housing covers, headlamp bezels, shower heads, fittings, smoothing irons, rotary switches, stove controls, fryer lids, door handles, (rear) mirror housing, (tailgate) screen wipers, sheathing for optical conductors.

Electrical and electronic applications which can be produced using the polyesters of the invention are plugs, plug components, plug connectors, cable harness components, cable mounts, cable mount components, three-dimensionally injection-molded cable mounts, electrical connector elements, mechatronic components, and optoelectronic components.

Possible uses in automobile interiors are dashboards, steering column switches, seat components, headrests, center consoles, gearbox components, and door modules, and possible automobile exterior components are door handles, headlamp components, exterior mirror components, windshield wiper components, windshield wiper protective housings, grilles, roof rails, sunroof frames, and exterior bodywork parts.

Possible uses of the polyesters in the kitchen and household sector are production of components for kitchen equipment, e.g. fryers, smoothing irons, buttons, and also garden and leisure sector applications, such as components for irrigation systems or garden equipment.

### EXAMPLES

### Component A

Polybutylene terephthalate with intrinsic viscosity IV 130 ml/g and with terminal carboxy group content 34 mval/kg (Ultradur® B 4500 from BASF SE) (IV measured in 0.5% by weight solution made of phenol/o-dichlorobenzene, 1:1 mixture at 25° C.).

### Component C/1

SAN having 19% by weight AN content and intrinsic viscosity 70 ml/g (measured in DMF, 0.5% by weight solution).

### Component C/2

SAN having 35% by weight AN content and intrinsic viscosity 65 ml/g (measured in DMF, 0.5% by weight solution).

### Component D/Comp 1

Component D/comp 1 used comprised a styrene-acrylonitrile-maleic anhydride terpolymer which had a constitution of 75/24.6/0.4 (% by weight), intrinsic viscosity: 66 ml/g.

### Component D/1

Component D/1 used comprised a styrene-acrylonitrile-maleic anhydride terpolymer which had a constitution of 74.5/24.5/1.0 (% by weight), intrinsic viscosity: 66 ml/g.

### Component D/2

Component D/2 used comprised a styrene-acrylonitrile-maleic anhydride terpolymer which had a constitution of 74.1/23.9/2.0 (% by weight), intrinsic viscosity: 67 ml/g.

### Component D/Comp 2

Component D/comp 2 used comprised a styrene-acrylonitrile-maleic anhydride terpolymer which had a constitution of 74/23.5/2.5 (% by weight), intrinsic viscosity: 68 ml/g.

### Production of Graft Copolymer E

### a) Production of Polystyrene Core

700 g of water, 3.4 g of the sodium salt of a C12- to C18-paraffinsulfonic acid, 1.75 g of potassium peroxodisulfate, 2.5 g of sodium hydrogencarbonate, 1 g of sodium pyrophosphate, and 50 g of a polystyrene seed latex (solids content=38.7%, d50=85 nm) were heated to 70° C. A mixture made of 550 g of styrene, 11.5 g of DCPA, and 10 g of divinylbenzene was then added within a period of 2 hours.
Once monomer addition had ended, the emulsion was kept at 65° C. for one further hour. The average particle diameter d 50 of the polystyrene core was 250 nm. The solids content of the emulsion was 38.5%.

### b) Production of Polybutyl Acrylate Shell

The following were added to the emulsion obtained: 10 g of the sodium salt of a C12- to C18-paraffinsulfonic acid, 6.5 g of potassium peroxodisulfate, 5 g of sodium hydrogencarbonate, and 2 g of sodium pyrophosphate, and 2490 g of water. 1730 g of butyl acrylate and 35 g of DCPA were added at 65° C. within a period of 3.5 h, and the mixture was then stirred at 65° C. for 2 further hours.
(d50=420 nm, solids content=38.6%.)

### c) Production of Polystyrene/Acrylonitrile Graft Shell

6070 g of the emulsion thus obtained were diluted with 2600 g of water, and 5 g of the sodium salt of a C12- to C18-paraffinsulfonic acid and 4.5 g of potassium peroxodisulfate were added. A mixture made of 790 g of styrene and 260 g of acrylonitrile were added dropwise at 65° C. within a period of 2 h, and the mixture was then stirred at 65° C. for 2 further hours (d50=500 nm, solids content=34.8%.)
The graft polymer E was precipitated from the emulsion at 95° C. by means of calcium chloride solution, and washed with water and dried in a stream of warm air.

### Component F

Glass fiber equipped with an epoxy size, fiber diameter 10 μm.

### Production and Testing of Molding Compositions

A twin-extruder was used to mix the components, and the melt temperature was 260° C. The melt was passed through a water bath and pelletized.

Mechanical properties were also determined on specimens produced by means of injection molding (melt temperature: 250° C./mold temp. 80° C.).

The impact resistance of the product was determined on ISO specimens to ISO 179 1eU. Ultimate tensile strength and tensile strain at break were determined to ISO 527. The thermal stability of the product was characterized via storage of tensile specimens at 120° C. for 500 h in a convection oven and a subsequent tensile test. The molding compositions were also processed at 300° C. melt temperature/80° C. mold temperature in order to assess process stability.

The constitution of the styrene copolymers used was determined by quantitative IR spectroscopy.

Table 1 lists the constitutions of the molding compositions and the results of the tests.

TABLE 1

| | Molding composition No. | | | | | | |
|---|---|---|---|---|---|---|---|
| Component [% by weight] | Comp 1 | Comp 2 | Comp 3 | 4 | 5 | Comp 6 | Comp 7 |
| C/1 | 10.7 | — | 6.7 | 6.7 | 6.7 | 6.7 | — |
| C/2 | — | 10.7 | — | — | — | — | 6.7 |
| A | 58.2 | 58.2 | 58.2 | 58.2 | 58.2 | 58.2 | 58.2 |
| D/comp 1 | — | — | 4 | — | — | — | — |
| D1 | — | — | — | 4 | — | — | 4 |
| D2 | — | — | — | — | 4 | — | — |
| D/comp 2 | — | — | — | — | — | 4 | — |
| E | 11.1 | 11.1 | 11.1 | 11.1 | 11.1 | 11.1 | 11.1 |
| F | 20 | 20 | 20 | 20 | 20 | 20 | 20 |
| aₙ [kJ/m²] | 52.9 | 49.7 | 53.3 | 62.6 | 61.7 | 53.5 | 53.7 |
| Ultimate tensile | 103 | 99 | 104 | 114 | 114 | 110 | 104 |
| strength [N/mm²] | | | | | | | |
| Tensile strain at break | 2.7 | 2.6 | 2.7 | 3.1 | 3.0 | 2.9 | 2.5 |
| [%] | | | | | | | |
| Ultimate tensile | 100 | 97 | 102 | 113 | 112 | 101 | 100 |
| strength after | | | | | | | |
| 500 h/120° C. [MPa] | | | | | | | |
| a_{n,} processing at | 42.3 | 40.4 | 41.4 | 58.7 | 56.7 | 37.4 | 45.3 |
| 300° C./80° C. [kJ/m²] | | | | | | | |

1-11. (canceled)

12. A thermoplastic molding composition comprising
A) from 2 to 98.5% by weight of at least one polyester,
B) from 0 to 70% by weight of at least one polycarbonate,
C) from 1 to 97.5% by weight of a copolymer made of
c₁) from 60 to 95% by weight of styrene or of substituted styrenes of the general formula I or a mixture of these 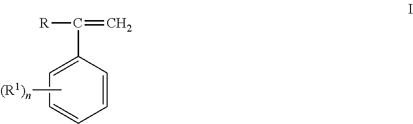
in which R is an alkyl radical having from 1 to 8 carbon atoms or a hydrogen atom and R¹ is an alkyl radical having from 1 to 8 carbon atoms, and n has the value 1, 2, or 3, and
c₂) from 5 to 40% by weight of at least one unsaturated nitrile,
D) from 0.5 to 30% by weight of a copolymer made of
d₁) from 49.5 to 93.5% by weight of structural units deriving from one or more vinylaromatic monomers,
d₂) from 6 to 50% by weight of structural units deriving from one or more vinyl cyanides,
d₃) from 0.5 to 2.4% by weight of structural units deriving from one or more dicarboxylic anhydrides, and
d₄) from 0 to 25% by weight of structural units deriving from other copolymerizable monomers,
where each of the % by weight values is based on the total weight of the structural units deriving from components d₁, d₂, d₃, and d₄, and the total of these % by weight values is 100% by weight,
E) from 0 to 50% by weight of a rubber which comprises no diene, and
F) from 0 to 60% by weight of other additives,
where the total of the percentages by weight of A) to F) does not exceed 100%.

13. The thermoplastic molding composition according to claim 12, comprising
A) from 10 to 97.5% by weight
B) from 0 to 60% by weight
C) from 1 to 97.5% by weight
D) from 0.5 to 30% by weight
E) from 1 to 40% by weight
F) from 0 to 60% by weight,
where the total of the percentages by weight of A) to F) is 100%.

14. The thermoplastic molding composition according to claim 12, comprising, as component E), a graft polymer composed of
E₁) from 40 to 80% by weight of a graft base made of an elastomeric polymer based on alkyl acrylates having from 1 to 8 carbon atoms in the alkyl radical and having a glass transition temperature below 10° C.,
E₂) from 20 to 60% by weight of a graft made of
E₂₁) from 60 to 95% by weight of styrene or of substituted styrenes of the general formula I or a mixture of these, and
E₂₂) from 5 to 40% by weight of at least one unsaturated nitrile.

15. The thermoplastic molding composition according to claim 13, comprising, as component E), a graft polymer composed of
E₁) from 40 to 80% by weight of a graft base made of an elastomeric polymer based on alkyl acrylates having from 1 to 8 carbon atoms in the alkyl radical and having a glass transition temperature below 10° C.,
E₂) from 20 to 60% by weight of a graft made of
E₂₁) from 60 to 95% by weight of styrene or of substituted styrenes of the general formula I or a mixture of these, and
E₂₂) from 5 to 40% by weight of at least one unsaturated nitrile.

16. The thermoplastic molding composition according to claim 12, comprising, as component D, a copolymer made of
d₁) from 49.2 to 93.2% by weight
d₂) from 6 to 50% by weight
d₃) from 0.8 to 2.2% by weight
d₄) from 0 to 25% by weight.

17. The thermoplastic molding composition according to claim 15, comprising, as component D, a copolymer made of
d₁) from 49.2 to 93.2% by weight
d₂) from 6 to 50% by weight
d₃) from 0.8 to 2.2% by weight
d₄) from 0 to 25% by weight.

18. The thermoplastic molding composition according to claim 12, comprising, as component D), a terpolymer made of
component d₁) styrene, α-methylstyrene, p-methylstyrene, tert-butylstyrene, vinylnaphthalene, or a mixture made of two or more of said monomers, component d₂) acrylonitrile, methacrylonitrile, or a mixture of said monomers, and component d₃) maleic anhydride, methylmaleic anhydride, itaconic anhydride, or a mixture made of two or more of said monomers.

19. The thermoplastic molding composition according to claim 12, in which the copolymer D) is a styrene-acrylonitrile-maleic anhydride copolymer.

20. The thermoplastic molding composition according to claim 17, in which the copolymer D) is a styrene-acrylonitrile-maleic anhydride copolymer.

21. The thermoplastic molding composition according to claim 12, in which component D) is obtainable via bulk polymerization or solution polymerization.

22. The thermoplastic molding composition according to claim 12, in which component D) is produced via themial polymerization without addition of any polymerization initiator.

23. The thermoplastic molding composition according to claim 12, where the difference in the nitrile content of components C) and D) is less than 10% by weight.

24. The thermoplastic molding composition according to claim 20, where the difference in the nitrile content of components C) and D) is less than 10% by weight.

25. A process for producing fibers, foils, and moldings which comprises utilizing the thermoplastic molding compositions according to claim 12.

26. A molding of any type, a fiber, or a foil obtainable from the thermoplastic molding compositions according to claim 12.
